(19) United States
(12) Patent Application Publication
(10) Pub. No.: US 2022/0272341 A1
(43) Pub. Date: Aug. 25, 2022

(54) DECODING DEVICE, DECODING METHOD, AND STORAGE MEDIUM

(71) Applicant: FUJITSU LIMITED, Kawasaki-shi (JP)

(72) Inventors: Akihiro Yamori, Kawasaki (JP); Kimihiko KAZUI, Kawasaki (JP)

(73) Assignee: FUJITSU LIMITED, Kawasaki-shi (JP)

(21) Appl. No.: 17/742,438

(22) Filed: May 12, 2022

Related U.S. Application Data
(63) Continuation of application No. PCT/JP2019/051563, filed on Dec. 27, 2019.

(51) Int. Cl. H04N 19/119; H04N 19/105; H04N 19/159; H04N 19/176

(52) U.S. Cl. CPC H04N 19/119; H04N 19/105; H04N 19/159; H04N 19/176

(57) ABSTRACT

A decoding device includes one or more memories; and one or more processors coupled to the one or more memories and the one or more processors configured to acquire a division shape of a block in a non-rectangular prediction unit based on positional information of one division node of two division nodes at which a partition that divides a block in a coding unit included in coded data into the block in the non-rectangular prediction unit intersects a boundary of the block in the coding unit and an angle of an intra-prediction mode used to perform intra-prediction in the block in the non-rectangular prediction unit, and perform intra-prediction of the block in the non-rectangular prediction unit obtained by dividing the block in the coding unit based on the division shape using the intra-prediction mode.

### CROSS-REFERENCE TO RELATED APPLICATION

This application is a continuation application of International Application PCT/JP2019/051563 filed on Dec. 27, 2019 and designated the U.S., the entire contents of which are incorporated herein by reference.

### FIELD

The present invention relates to a decoding device, a decoding method, and a storage medium.

### BACKGROUND ART

In the field of video coding, there has been known high efficiency video coding (HEVC), which is the latest coding scheme. Moreover, following the HEVC, the study of next-generation versatile video coding (WC) has been underway in the joint video exploration team (JVET) aiming for next-generation standardization.

In JVET-J0023, geometric partition (GEO) has been proposed as one of application techniques. The GEO extends rectangular division of blocks in coding units to non-rectangular division, such as division into triangles or trapezoids, thereby reducing prediction errors to improve coding efficiency. In one aspect, it is expected that the prediction efficiency is improved by dividing the block in the coding unit with a partition matched to an edge component such as a boundary between the foreground and the background.

A division shape of the GEO is represented by two coordinate points P₀ and P₁ on the block boundary. For example, a four-bit code amount for identifying 16 templates and a six-to-eight-bit code amount indicating each of the two coordinate points P₀ and P₁ are needed for each block. Note that the code amount of the two coordinate points P₀ and P₁ depends on N of the maximum value (=2^{N}) of the block in the coding unit.

Furthermore, in JVET-L0208, there has been proposed, as multiple prediction (MP), a method of limiting the templates to 12 patterns by limiting the position of dividing the block in the coding unit in the block division of the GEO. In the MP, a division position in each template is fixed so that the coordinates of the two coordinate points P₀ and P₁ described above are not transmitted. Therefore, according to the MP, the code amount is suppressed to 4 bits for identifying the block division template.

Patent Document 1: Japanese Laid-open Patent Publication No. 2012-23597; Patent Document 2: Japanese Laid-open Patent Publication No. 2019-12980; Non-Patent Document 1: M. Blaser, J. Sauer, and M. Wien, “Description of SDR and 360° video coding technology proposal by RWTH Aachen University”, Doc. JVET-J0023, Joint Video Experts Team of ITU-T VCEG and ISO/IEC MPEG, San Diego, USA, 10th meeting, April 2018.

### SUMMARY

According to an aspect of the embodiments, a decoding device includes one or more memories; and one or more processors coupled to the one or more memories and the one or more processors configured to acquire a division shape of a block in a non-rectangular prediction unit based on positional information of one division node of two division nodes at which a partition that divides a block in a coding unit included in coded data into the block in the non-rectangular prediction unit intersects a boundary of the block in the coding unit and an angle of an intra-prediction mode used to perform intra-prediction in the block in the non-rectangular prediction unit, and perform intra-prediction of the block in the non-rectangular prediction unit obtained by dividing the block in the coding unit based on the division shape using the intra-prediction mode.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an exemplary functional configuration of a decoding device according to a first embodiment;

FIG. 2 is a diagram illustrating an exemplary GEO template;

FIG. 3 is a diagram illustrating an exemplary intra-prediction mode;

FIG. 4 is a diagram illustrating an exemplary intra-prediction mode;

FIG. 5A is a diagram illustrating an exemplary coding scheme of a division node;

FIG. 5B is a diagram illustrating an exemplary coding scheme of the division node;

FIG. 6 is a flowchart illustrating a procedure of a decoding process according to the first embodiment;

FIG. 7 is a flowchart illustrating a procedure of a decoding process according to an application example of the first embodiment;

FIG. 8 is a block diagram illustrating an exemplary functional configuration of a coding device 2 according to a second embodiment;

FIG. 9 is a flowchart illustrating a procedure of a coding process according to the second embodiment;

FIG. 10 is a flowchart illustrating a procedure of a coding process according to an application example of the second embodiment; and

FIG. 11 is a diagram illustrating an exemplary hardware configuration of a computer.

### DESCRIPTION OF EMBODIMENTS

According to the GEO described above, the code amount for representing the partition for dividing the block in the coding unit into blocks in non-rectangular prediction units increases, whereby the code amount used to identify the non-rectangular division shape may increase.

Having said that, when the templates for the block division are limited to 12 patterns as in the MP described above, it is difficult to match a partition position with the video edge component, whereby the prediction error increases. In this case, it is highly likely that the code amount for representing the prediction error exceeds the code amount used to identify the non-rectangular division shape.

In one aspect, it is an object of the present invention to provide a decoding device, a coding device, a decoding method, and a decoding program capable of suppressing a code amount used to identify a non-rectangular division shape.

It becomes possible to suppress a code amount used to identify a non-rectangular division shape.

Hereinafter, a decoding device, a coding device, a decoding method, and a decoding program according to the present application will be described with reference to the accompanying drawings. Note that the present embodiments do not limit the technology disclosed. Additionally, each of the embodiments may be suitably combined within a range without causing contradiction between processing contents.

### First Embodiment

[Configuration of Decoding Device]

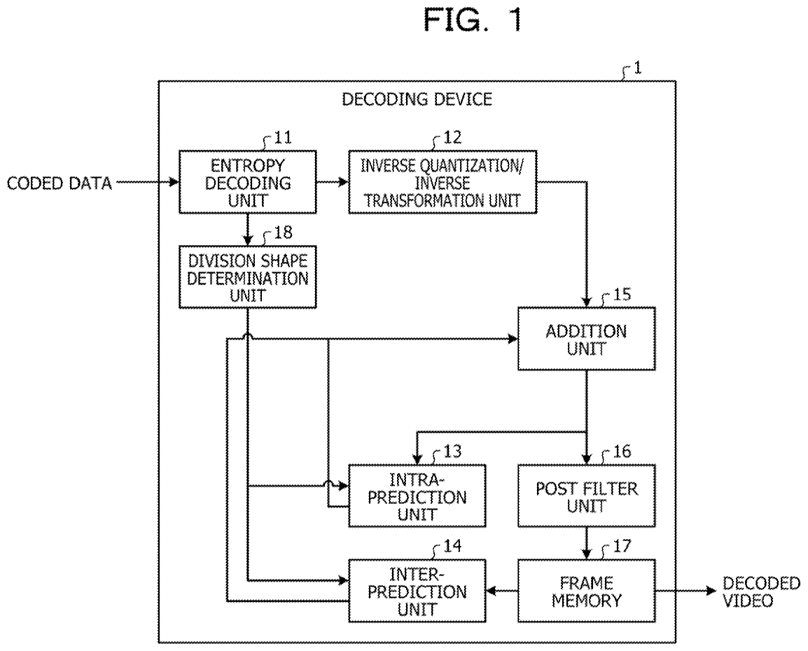

FIG. 1 is a block diagram illustrating an exemplary functional configuration of a decoding device according to a first embodiment. A decoding device 1 illustrated in FIG. 1 decodes coded data of input video for each block in a unit of coding, which is what is called a coding unit (CU).

As illustrated in FIG. 1, the decoding device 1 includes an entropy decoding unit 11, an inverse quantization/inverse transformation unit 12, an intra-prediction unit 13, an inter-prediction unit 14, an addition unit 15, a post filter unit 16, a frame memory 17, and a division shape calculation unit 18.

As one embodiment, the decoding device 1 may implement the functions corresponding to the individual units as individual circuits. In addition, the decoding device 1 may also be implemented as an integrated circuit in which circuits for implementing the functions of the individual units are integrated.

As another embodiment, the decoding device 1 may be virtually implemented by a hardware processor such as a central processing unit (CPU), a micro processing unit (MPU), or the like. That is, the processor reads, in addition to an operating system (OS), a decoding program in which the functions of the individual units described above are modularized from a storage device (not illustrated) such as a hard disk drive (HDD), an optical disk, a solid state drive (SSD), or the like. Then, the processor executes the decoding program described above, thereby developing a process corresponding to the functions of the individual units described above on a work area of a memory such as a random access memory (RAM) or the like. As a result of executing the decoding program in this manner, the functions of the individual units described above are virtually implemented as a process. Note that, although the CPU and the MPU are exemplified as an example of the processor here, the functions of the individual units described above may be implemented by any processor regardless of a general-purpose type or a dedicated type. In addition, all or a part of the functions of the individual units described above may be implemented by a hard wired logic such as an application specific integrated circuit (ASIC), a field programmable gate array (FPGA), or the like.

Furthermore, a memory accessible by the processor or a partial storage area included in the memory is allocated to each of the units described above as a work area. For example, various semiconductor memory elements, such as a main storage device including a RAM, a flash memory, and the like, may be used as an example of the memory. Furthermore, the storage area accessible by the processor may not necessarily be implemented as a work area in the memory, and may be a swap area saved in an external storage device or an auxiliary storage device.

The entropy decoding unit 11 performs entropy decoding on the coded data of the video. According to such entropy decoding, prediction parameters of the block in the coding unit, such as an intra-prediction mode, a motion parameter, and the like as well as a prediction residual of a pixel value having been subject to orthogonal transformation and quantization and the like are obtained. Of these, the prediction residual of the pixel value having been subject to the orthogonal transformation and the quantization is output to the inverse quantization/inverse transformation unit 12 while the prediction parameters are output to the intra-prediction unit 13 and the inter-prediction unit 14 via the division shape calculation unit 18 to be described later.

The inverse quantization/inverse transformation unit 12 performs inverse quantization and inverse orthogonal transformation on the prediction residual of the pixel value having been subject to the orthogonal transformation and the quantization to restore the prediction residual of the pixel value. The prediction residual of the pixel value restored by the inverse quantization and the inverse orthogonal transformation in this manner is output to the addition unit 15.

The intra-prediction unit 13 and the inter-prediction unit 14 outputs, to the addition unit 15, a block in a prediction unit obtained by dividing the block in the coding unit into one or multiple pieces, which is a pixel value obtained as a result of intra-prediction or inter-prediction for each of what is called prediction units (PUs). Note that the block in the coding unit may include only the blocks in the prediction units coded in a prediction mode of either the intra-prediction or the inter-prediction, or the blocks in the prediction units coded in both of the prediction modes may be included in a mixed manner.

The intra-prediction unit 13 predicts, on the basis of a decoded pixel value of an adjacent pixel adjacent to the block in the prediction unit and the intra-prediction mode, a pixel value of the block in the prediction unit. That is, the intra-prediction unit 13 receives an input of the intra-prediction mode output from the division shape calculation unit 18 to be described later and the decoded pixel value of the adjacent pixel output from the addition unit 15, and predicts a pixel value of the block in the prediction unit. The pixel value of the block in the prediction unit predicted in this manner is output to the addition unit 15.

The inter-prediction unit 14 receives an input of the motion parameter, such as a motion vector and a reference picture index, output from the division shape calculation unit 18 to be described later and a pixel value of the reference picture output from the frame memory 17, and predicts a pixel value of the block in the prediction unit. For example, the inter-prediction unit 14 refers to the pixel value of the reference picture corresponding to the index of the reference picture among the pictures saved in the frame memory 17 on the basis of the motion vector, thereby predicting a pixel value of the block in the prediction unit.

The addition unit 15 adds the pixel value of the block in the coding unit output by the intra-prediction unit 13 or the inter-prediction unit 14 and the prediction residual of the pixel value of the block in the coding unit output from the inverse quantization/inverse transformation unit 12. As a result, the decoded pixel value of the block in the coding unit is obtained. The decoded pixel value of the block in the coding unit obtained in this manner is output to the post filter unit 16.

The post filter unit 16 applies a post filter to the decoded pixel value output by the addition unit 15. In one aspect, the application of the post filter reduces a quantization error of the decoded pixel value. The decoded pixel value to which the post filter is applied in this manner is output to the frame memory 17.

The decoded pixel value after the post filter is applied is drawn in the frame memory 17. As a result, the picture of the video is accumulated in the frame memory 17 for each frame. The pictures accumulated in this manner may be output to a predetermined output destination, such as a display device or a program, and the picture of the frame corresponding to the index of the reference picture is referred to at the time of inter-prediction. For example, the frame memory 17 may be implemented as a graphics memory or a video memory, or may be implemented as a partial storage area of the main memory.

The division shape calculation unit 18 calculates a division shape of the block in the prediction unit.

In a case where the block in the coding unit is divided into blocks in rectangular prediction units as the division from the CU to the PU, the division shape is the same as H.264 or HEVC. Accordingly, hereinafter, an example in which a coding device performs GEO division for dividing the block in the coding unit into blocks in two non-rectangular prediction units will be described.

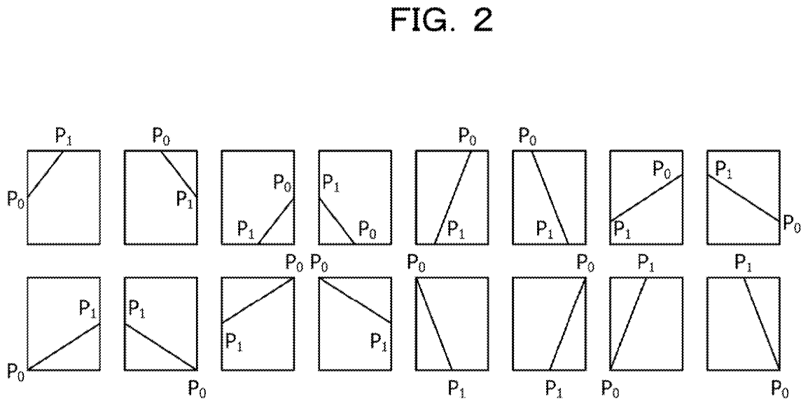

For example, according to the GEO proposed by JVET-J0023, the template number applied at the time of GEO division among 16 templates is coded. FIG. 2 is a diagram illustrating an exemplary GEO template. As illustrated in FIG. 2, according to the GEO, 16 patterns of templates are defined with patterns in which two division nodes P₀ and P₁ of a partition are placed on edges or vertices on boundaries of the block in the coding unit. Moreover, according to the GEO, the coordinates of the two division nodes P₀ and P₁ where the partition for dividing the block in the coding unit into the blocks in the two prediction units intersects the boundaries of the block in the coding unit are coded. Accordingly, a four-bit code amount is used for the template number, and a six-to-eight-bit code amount is used for each of the two division nodes P₀ and P₁.

Furthermore, according to the MP proposed by JVET-L0208, the position at which the block in the coding unit is divided is limited in the GEO block division, thereby limiting the templates to 12 patterns. In the MP, the division position in each template is fixed so that the coordinates of the two division nodes P₀ and P₁ described above are not coded. Therefore, according to the MP, the code amount is suppressed to 4 bits for identifying the block division template.

However, according to the GEO proposed by JVET-J0023, the code amount for representing the partition for dividing the block in the coding unit into non-rectangles increases, whereby the code amount for indicating the division shape of the block in the prediction unit may increase.

Having said that, when the templates for the block division are limited to 12 patterns as in the MP proposed by JVET-L0208, it is difficult to match a partition position with a video edge component, whereby a prediction error increases. In this case, it is highly likely that the code amount for representing the prediction error exceeds the code amount indicating the division shape of the block in the prediction unit, whereby coding efficiency is lowered.

In view of the above, in the present embodiment, a task of increasing the code amount used to identify a non-rectangular division shape is set as merely one aspect of a problem of a decrease in coding efficiency. Under such a task setting, the present embodiment adopts a problem-solving approach that substitutes an angle of the intra-prediction mode for an angle of the GEO partition to be identified motivated by the knowledge that the angle of the intra-prediction mode is highly correlated with the angle of the GEO partition.

As an idea to achieve the problem-solving approach described above, at a time of video coding, the angle of the partition is set to be the angle same as the angle of the intra-prediction mode in a case of performing the GEO division for dividing the block in the coding unit into the blocks in the two non-rectangular prediction units.

In coding after H.264/AVC, the intra-prediction is adopted as I-picture prediction. This is to generate, as prediction of a block with an I-picture, a prediction image from a coded adjacent pixel of the block to code a difference. For example, H.264 supports up to 9 patterns, HEVC supports up to 35 patterns, and WC supports up to 86 patterns of the intra-prediction modes.

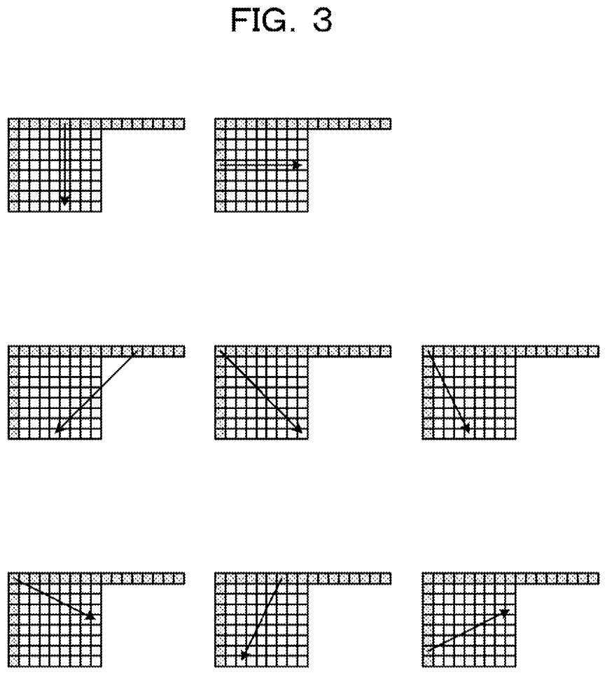

FIG. 3 is a diagram illustrating an example of the intra-prediction mode. FIG. 3 illustrates the intra-prediction mode according to H.264. In FIG. 3, as an example, blocks in 8×8 coding units are illustrated in white, and adjacent pixels adjacent to the blocks in the coding units are illustrated by hatching. Moreover, in FIG. 3, directions of the adjacent pixels referred to at the time of predicting pixels of the blocks in the coding units are indicated by arrows. As illustrated in FIG. 3, H.264 supports eight directions, including horizontal, vertical, and 45-degree directions, as the directions of the intra-prediction mode. A weight determination formula of the prediction image calculated from the adjacent pixels differs depending on a prediction direction. Although illustration is omitted here, H.264 supports the intra-prediction mode such as Planer and Direct Current (DC).

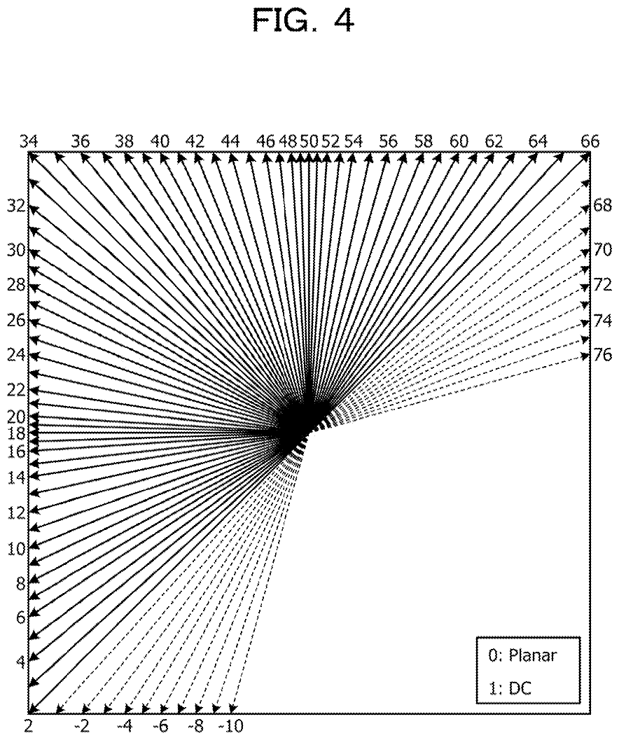

FIG. 4 is a diagram illustrating an example of the intra-prediction mode. FIG. 4 illustrates the intra-prediction mode according to WC. In FIG. 4, directions of the adjacent pixels referred to at the time of predicting pixels of the blocks in the coding units are indicated by arrows. Here, while only even-numbered directions of 2 to 66 illustrated in FIG. 4 are supported in the conventional HEVC, in the WC, −1 to −10 and 67 to 76 intra-prediction modes are added including odd numbers of 2 to 66 from the aspect of improving intra-prediction efficiency of rectangular blocks.

Here, a combination of the prediction modes of the blocks in the two prediction units having been subject to the GEO division may be any of four patterns of (1) Intra & Intra, (2) Intra & Inter, (3) Inter & Intra, and (4) Inter & Inter. For example, in a case where only one block in the prediction unit in which the prediction mode is the intra-prediction is included, that is, in the patterns of (2) and (3), the angle of the intra-prediction mode of the block in the prediction unit in which the prediction mode is the intra-prediction is used as the angle of the partition. Furthermore, in a case where the prediction modes of both of the blocks in the two prediction units are the intra-prediction, that is, in the pattern of (1), the angle of the intra-prediction mode of the block in the prediction unit that shares a predetermined vertex of the block in the coding unit, for example, an upper-left vertex P [0, 0], is used as the angle of the partition.

In such a situation where the angle of the partition is determined, if the coordinates of one of the division nodes P₀ and P₁ on the boundary of the block in the coding unit can be set, the coordinates of the other can be uniquely identified.

As merely an example, GEO division information of the adjacent block adjacent to the block in the coding unit being processed may be used to determine the division node. For example, in a case where the GEO division is performed in the adjacent block, it is possible to set, as the division node, one of two intersection points at which the extended line obtained by extending the line segment corresponding to the partition set in the adjacent block in the direction of the coding block being processed intersects the boundary of the coding block being processed. If it is possible to set, of the two intersection points, the intersection point closest to the adjacent block as the division node P₀, it is also possible to set the intersection point with a longer distance from the adjacent block as the division node P₁.

As another example, it is possible to use the GEO division information of the reference picture referred to in frames before and after the coding block being processed to determine the division node. For example, it is possible to set the division nodes P₀ or P₁ at the positions same as those of the division nodes P₀ and P₁ set in the block referred to in the reference picture on the basis of the motion vector.

The block in the coding unit is divided into the blocks in the prediction unit according to the partition set in this manner, and then the position of one division node of the two division nodes is coded as GEO division information.

Hereinafter, an example of coding the division node P₀ among the division nodes P₀ and P₁ will be described as merely an example of the GEO division information, but it is to be naturally noted that the division node P₁ may be coded.

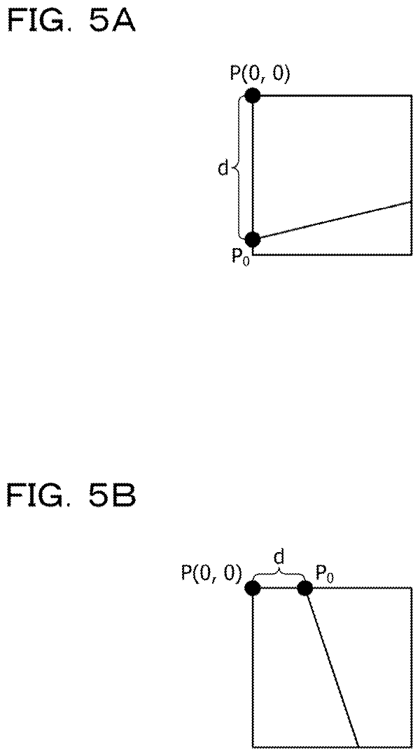

For example, the position of the division node P₀ may be defined by a distance d obtained by searching the boundary of the block clockwise or counterclockwise from an origin P (0, 0) at the upper-left vertex of the block in the coding unit to the division node P₀. FIGS. 5A and 5B are diagrams illustrating an exemplary coding scheme of the division node. For example, in a case where the intra-prediction refers to the left adjacent pixel of the block in the coding unit, as illustrated in FIG. 5A, the distance d obtained by searching the boundary of the block counterclockwise from the origin P (0, 0) to the division node P₀ is coded as GEO division information. Meanwhile, in a case where the intra-prediction refers to the upper adjacent pixel of the block in the coding unit, as illustrated in FIG. 5B, the distance d obtained by searching the boundary of the block clockwise from the origin P (0, 0) to the division node P₀ is coded as GEO division information.

As described above, in a case where a sub-block in which the prediction mode is the intra-prediction is included in any of sub-blocks of the block in the coding unit, the distance d from the origin P (0, 0) of the block in the coding unit to the division node P₀, that is, positional information of the division node P₀, is transmitted as the GEO division information. Note that, in a case where the block in the prediction unit in which the prediction mode is the intra-prediction is not included in any of the sub-blocks of the block in the coding unit, the template number and the coordinates of the two division nodes are transmitted as the GEO division information in a similar manner to the existing GEO.

In response to such GEO division information coding, the division shape calculation unit 18 decodes the positional information of the division node P₀ as the GEO division information in a case where the sub-block in which the prediction mode is the intra-prediction is included in any of the sub-blocks of the block in the coding unit. Then, the division shape calculation unit 18 calculates coordinates of the division node P₁ on the basis of the angle of the intra-prediction mode of the sub-block and the division node P₀. For example, the coordinates of the division node P₁ may be calculated by obtaining the intersection points at which the straight line extending from the division node P₀ at the angle of the intra-prediction mode intersects the boundary of the block in the coding unit. With the coordinates of the division node P₁ calculated in this manner, it becomes possible to identify the partition defined by the two division nodes P₀ and P₁, whereby it becomes possible to calculate the division shape for dividing the CU into the non-rectangular PU.

[Decoding Process Flow]

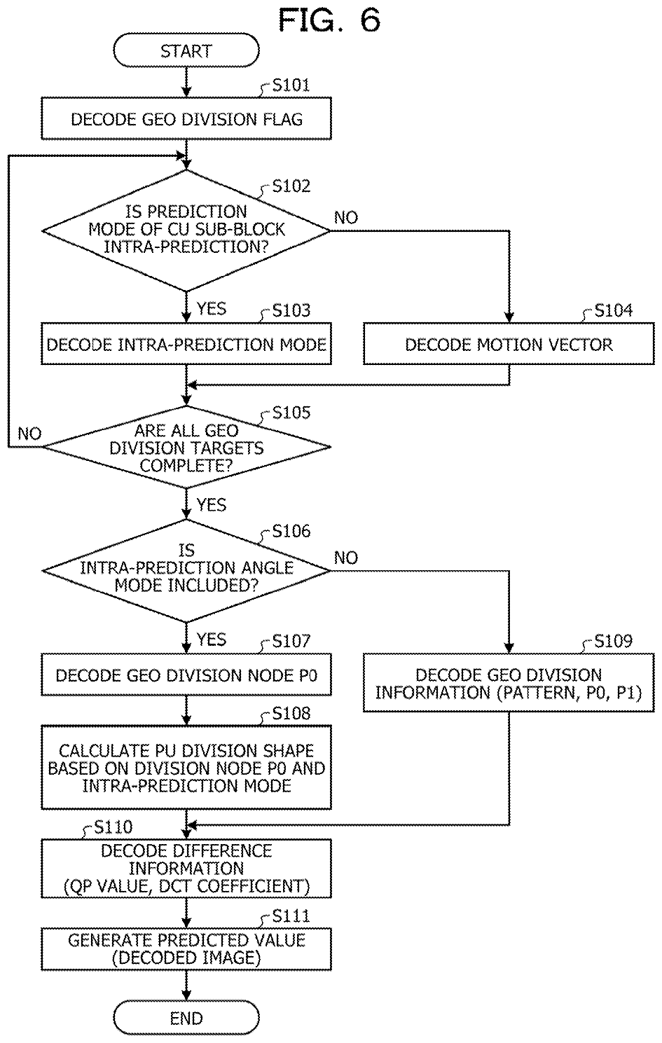

FIG. 6 is a flowchart illustrating a procedure of a decoding process according to the first embodiment. This process starts as merely an example when data of the block in the coding unit is input to the entropy decoding unit 11.

As illustrated in FIG. 6, the entropy decoding unit 11 decodes a GEO division flag set in the block in the coding unit (step S101). While the “GEO division flag” referred to here is set to “1” when GEO division is carried out in the block in the coding unit, it is set to “0” when the GEO division is not carried out in the block in the coding unit.

Subsequently, the entropy decoding unit 11 determines whether the prediction mode of the sub-block is the intra-prediction or the inter-prediction on the basis of an intra/inter determination flag of the block in the prediction unit, which is the sub-block of the block in the coding unit (step S102).

At this time, when the prediction mode of the sub-block is the intra-prediction, which is when the intra/inter determination flag is “1” (Yes in step S102), the entropy decoding unit 11 decodes the intra-prediction mode (step S103).

On the other hand, when the prediction mode of the sub-block is the inter-prediction, which is when the intra/inter determination flag is “0” (No in step S102), the entropy decoding unit 11 decodes the motion parameter such as the motion vector, the index of the reference picture, and the like (step S104).

Then, until the prediction modes of all the sub-blocks are determined (No in step S105), the process from step S102 described above to step S104 described above is repeated. Thereafter, when the prediction modes of all the sub-blocks are determined (Yes in step S105), the entropy decoding unit 11 determines whether or not a sub-block in which the prediction mode is the intra-prediction is included in any of the sub-blocks of the block in the coding unit (step S106).

Here, if the sub-block in which the prediction mode is the intra-prediction is included in any of the sub-blocks of the block in the coding unit (Yes in step S106), the entropy decoding unit 11 decodes the positional information of the division node P₀ as the GEO division information (step S107). Then, the division shape calculation unit 18 calculates the coordinates of the division node P₁ on the basis of the angle of the intra-prediction mode of the sub-block and the division node P₀, thereby calculating the division shape for dividing the CU into the non-rectangular PU (step S108).

On the other hand, if no block in the prediction unit in which the prediction mode is the intra-prediction is included is any of the sub-blocks of the block in the coding unit (No in step S106), the entropy decoding unit 11 decodes the template number and the coordinates of the two division nodes P₀ and P₁ as the GEO division information (step S109).

In this manner, the division shape of the PU is identified in step S108 or step S109 described above. Then, when the division shape of the PU is identified, the following process is carried out for each PU. For example, in a PU in which the prediction mode is the intra-prediction, the intra-prediction unit 13 predicts a pixel value of the PU on the basis of the intra-prediction mode obtained in step S103 and the decoded pixel value of the adjacent pixel output from the addition unit 15. Furthermore, in a PU in which the prediction mode is the inter-prediction, the inter-prediction unit 14 predicts a pixel value of the PU on the basis of the motion parameter obtained in step S104, such as the motion vector and the index of the reference picture, and the pixel value of the reference picture output from the frame memory 17.

Furthermore, the inverse quantization/inverse transformation unit 12 performs the inverse quantization and the inverse orthogonal transformation on the prediction residual of the pixel value having been subject to the orthogonal transformation and the quantization, thereby decoding difference information (QP value and DCT coefficient) (step S110).

Thereafter, the addition unit 15 adds the pixel value of the block in the coding unit output from the intra-prediction unit 13 or the inter-prediction unit 14 and the prediction residual of the pixel value of the block in the coding unit obtained in step S110, thereby generating a decoded pixel value of the block in the coding unit (step S111).

The decoded pixel value of the block in the coding unit generated in step S111 is output to the frame memory 17 after the post filter is applied thereto. With the decoded pixel value after the post filter application drawn in the frame memory 17 in this manner, the picture of the video is accumulated in the frame memory 17 for each frame.

### One Aspect of Effects

As described above, the decoding device 1 according to the present embodiment calculates the division shape for dividing the CU into the non-rectangular PU on the basis of the angle of the intra-prediction mode and one division node P₀ included in the GEO partition. In this manner, the angle of the intra-prediction mode is substituted for the angle of the GEO partition to be identified, whereby it becomes possible to identify the division shape of the PU by only causing the coding device to code and transmit one division node of the two division nodes. Therefore, according to the decoding device 1 according to the present embodiment, it becomes possible to suppress the code amount used to identify the non-rectangular division shape.

### Application Example

Next, an application example of the decoding device 1 according to the present embodiment will be described. While the example of substituting the angle of the intra-prediction mode for the angle of the GEO partition to be identified has been described in the first embodiment above, it is also possible to substitute the angle of the GEO partition for the angle of the intra-prediction mode to be identified, and an example thereof will be exemplified below as an application example.

That is, in a case where the angle of the GEO partition is substituted for the angle of the intra-prediction mode to be identified in the decoding device 1, the coding device carries out the existing GEO division proposed by JVET-J0023. Meanwhile, in the coding device, the angle of the GEO partition is calculated on the basis of the template number and the coordinates of the two division nodes included in the GEO division information coded at the time of GEO division. Then, the coding device selects, among the intra-prediction modes supported by WC, the intra-prediction mode of the angle corresponding to the angle of the GEO partition, that is, the angle closest to the angle of the GEO partition. The intra-prediction mode selected in this manner is set to, among the sub-blocks of the block in the coding unit, a sub-block in which the prediction mode is the intra-prediction.

While an example of setting the intra-prediction mode corresponding to a fixed length of 5 bits is described here as merely an example, it is also possible to set the intra-prediction mode of the angle closest to the angle of the GEO partition as a most probable mode (MPM) element. In this case, with an index for identifying the MPM element assigned to the sub-block in which the prediction mode is the intra-prediction, it becomes possible to suppress the code amount of the intra-prediction mode as compared with the fixed length.

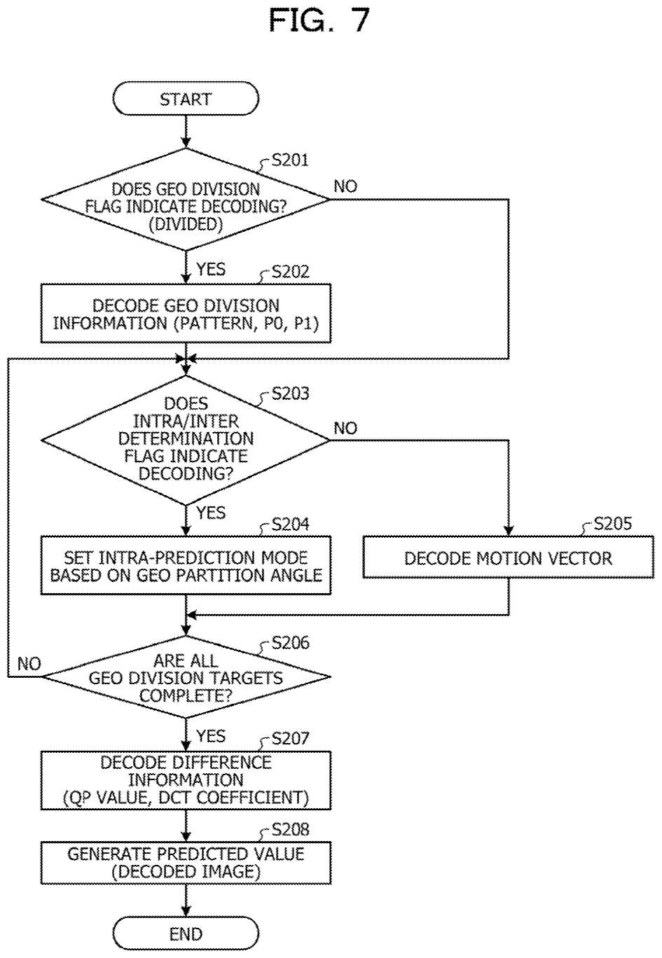

In a case where the setting of the intra-prediction mode described above is performed by the coding device, the decoding device 1 includes, instead of the division shape calculation unit 18, an intra-prediction mode setting unit that sets the intra-prediction mode to the sub-block in which the prediction mode is the intra-prediction on the basis of the angle of the GEO partition. A decoding process to be executed by the decoding device 1 including such an intra-prediction mode setting unit will be described with reference to FIG. 7.

FIG. 7 is a flowchart illustrating a procedure of the decoding process according to the application example of the first embodiment. This process starts as merely an example when data of the block in the coding unit is input to the entropy decoding unit 11.

As illustrated in FIG. 7, when the GEO division flag of the block in the coding unit decoded by the entropy decoding unit 11 is “1”, which is when the GEO division is carried out in the block in the coding unit (Yes in step S201), the entropy decoding unit 11 decodes the GEO division information including the template number and the coordinates of the two division nodes (step S202). Note that, when the GEO division flag is “0”, which is when no GEO division is carried out in the block in the coding unit (No in step S201), the processing of step S202 is skipped.

Subsequently, the entropy decoding unit 11 determines whether the prediction mode of the sub-block is the intra-prediction or the inter-prediction on the basis of the intra/inter determination flag of the block in the prediction unit, which is the sub-block of the block in the coding unit (step S203).

At this time, when the prediction mode of the sub-block is the intra-prediction, which is when the intra/inter determination flag is “1” (Yes in step S203), the intra-prediction mode setting unit sets, in the sub-block, the intra-prediction mode of the angle that approximates the angle of the GEO partition calculated from the template number and the coordinates of the two division nodes included in the GEO division information (step S204).

On the other hand, when the prediction mode of the sub-block is the inter-prediction, which is when the intra/inter determination flag is “0” (No in step S203), the entropy decoding unit 11 decodes the motion parameter such as the motion vector, the index of the reference picture, and the like (step S205).

Then, until the prediction modes of all the sub-blocks are determined (No in step S206), the process from step S203 described above to step S205 described above is repeated. Thereafter, when the prediction modes of all the sub-blocks are determined (Yes in step S206), the division shape of the PU is identified on the basis of the GEO division information obtained in step S202 described above.

When the division shape of the PU is identified in this manner, the following process is carried out for each PU. For example, in a PU in which the prediction mode is the intra-prediction, the intra-prediction unit 13 predicts a pixel value of the PU on the basis of the intra-prediction mode obtained in step S204 and the decoded pixel value of the adjacent pixel output from the addition unit 15. Furthermore, in a PU in which the prediction mode is the inter-prediction, the inter-prediction unit 14 predicts a pixel value of the PU on the basis of the motion parameter obtained in step S205, such as the motion vector and the index of the reference picture, and the pixel value of the reference picture output from the frame memory 17.

Furthermore, the inverse quantization/inverse transformation unit 12 performs the inverse quantization and the inverse orthogonal transformation on the prediction residual of the pixel value having been subject to the orthogonal transformation and the quantization, thereby decoding difference information (QP value and DCT coefficient) (step S207).

Thereafter, the addition unit 15 adds the pixel value of the block in the coding unit output from the intra-prediction unit 13 or the inter-prediction unit 14 and the prediction residual of the pixel value of the block in the coding unit obtained in step S207, thereby generating a decoded pixel value of the block in the coding unit (step S208).

The decoded pixel value of the block in the coding unit generated in step S208 is output to the frame memory 17 after the post filter is applied thereto. With the decoded pixel value after the post filter application drawn in the frame memory 17 in this manner, the picture of the video is accumulated in the frame memory 17 for each frame.

As described above, the decoding device 1 according to the application example of the first embodiment described above sets the intra-prediction mode corresponding to the angle of the GEO partition to the sub-block in which the prediction mode is the intra-prediction. As a result, it becomes possible to substitute the angle of the GEO partition for the identification of the intra-prediction mode on the side of the decoding device 1. Accordingly, it becomes possible to omit the coding of the intra-prediction mode at the time of the GEO division on the side of the coding device, whereby it becomes possible to suppress the code amount of the intra-prediction mode.

### Second Embodiment

In the present embodiment, a coding device 2 that generates coded data of video transmitted to the decoding device 1 according to the first embodiment described above will be described.

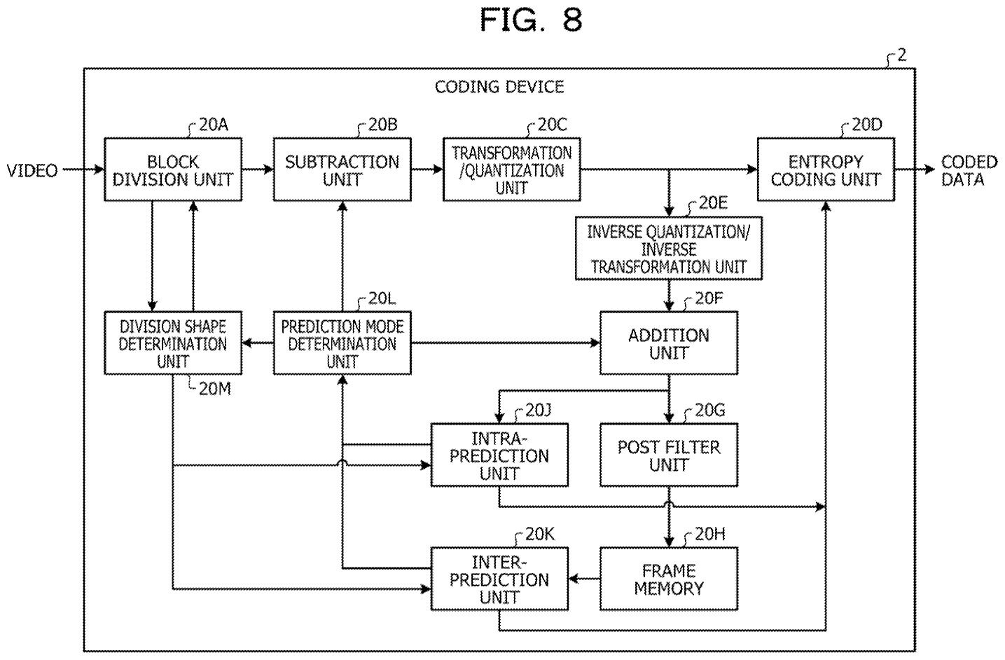

FIG. 8 is a block diagram illustrating an exemplary functional configuration of the coding device 2 according to a second embodiment. As illustrated in FIG. 8, the coding device 2 includes a block division unit 20A, a subtraction unit 20B, a transformation/quantization unit 20C, an entropy coding unit 20D, an inverse quantization/inverse transformation unit 20E, an addition unit 20F, a post filter unit 20G, a frame memory 20H, an intra-prediction unit 203, an inter-prediction unit 20K, a prediction mode determination unit 20L, and a division shape determination unit 20M.

As one embodiment, the coding device 2 may implement the functions corresponding to the individual units as individual circuits. In addition, the coding device 2 may also be implemented as an integrated circuit in which circuits for implementing the functions of the individual units are integrated.

As another embodiment, the coding device 2 may be virtually implemented by a hardware processor such as a CPU, an MPU, or the like. That is, the processor reads, in addition to an OS, a coding program in which the functions of the individual units described above are modularized from a storage device (not illustrated) such as an HDD, an optical disk, an SSD, or the like. Then, the processor executes the coding program described above, thereby developing a process corresponding to the functions of the individual units described above on a work area of a memory such as a RAM or the like. As a result of executing the coding program in this manner, the functions of the individual units described above are virtually implemented as a process. Note that, although the CPU and the MPU are exemplified as an example of the processor here, the functions of the individual units described above may be implemented by any processor regardless of a general-purpose type or a dedicated type. In addition, all or a part of the functions of the individual units described above may be implemented by a hard wired logic such as an ASIC, an FPGA, or the like.

Furthermore, a memory accessible by the processor or a partial storage area included in the memory is allocated to each of the units described above as a work area. For example, various semiconductor memory elements, such as a main storage device including a RAM, a flash memory, and the like, may be used as an example of the memory. Furthermore, the storage area accessible by the processor may not necessarily be implemented as a work area in the memory, and may be a swap area saved in an external storage device or an auxiliary storage device.

The block division unit 20A divides each picture of the video into predetermined blocks. For example, the block division unit 20A performs coding tree unit (CTU) division that divides, for each video frame, a picture of the frame into blocks in a coding tree unit called a CTU. Moreover, the block division unit 20A executes CU division that divides the block in the coding tree unit into blocks in a coding unit, that is, the CU described above. Moreover, the block division unit 20A executes PU division that divides the block in the coding unit into blocks in a plurality of prediction units, that is, the PUs described above. Furthermore, the block division unit 20A further executes TU division that divides the block in the coding unit into blocks in a plurality of transformation units, that is, transform units (TUs).

Here, in a case of executing the PU division, it is determined whether or not to perform GEO division for dividing the CU into non-rectangular PUs in the GEO proposed by JVET-J0023 or the like. At this time, while a GEO division flag is set to “1” in a case where the GEO division is performed, the GEO division flag is set to “0” in a case where the GEO division is not performed. Note that, in the case where the GEO division is performed, a division shape of the PU is determined by the division shape determination unit 20M to be described later.

The subtraction unit 20B subtracts a predicted value of the block in the coding unit output from the prediction mode determination unit 20L to be described later from a pixel value of the block in the coding unit output from the block division unit 20A. A prediction residual of the pixel value of the block in the coding unit obtained by such subtraction is output to the transformation/quantization unit 20C.

The transformation/quantization unit 20C performs orthogonal transformation and quantization on the prediction residual of the pixel value of the block in the coding unit output from the subtraction unit 20B. The prediction residual of the pixel value of the block in the coding unit having been subject to the quantization and the orthogonal transformation in this manner is output to the entropy coding unit 20D and the inverse quantization/inverse transformation unit 20E.

The entropy coding unit 20D performs entropy coding on an intra-prediction mode output by the prediction mode determination unit 20L and a prediction parameter, such as a motion parameter, output by the inter-prediction unit 20K together with the prediction residual of the pixel value of the block in the coding unit having been subject to the quantization and the orthogonal transformation performed by the transformation/quantization unit 20C. The coded data of the video on which the entropy coding has been performed in this manner is output to a predetermined output destination, such as any program, a transmission device, or the like.

The inverse quantization/inverse transformation unit 20E performs inverse quantization and inverse transformation on the prediction residual of the pixel value of the block in the coding unit having been subject to the orthogonal transformation and the quantization performed by the transformation/quantization unit 20C, thereby restoring the prediction residual of the pixel value. The prediction residual of the pixel value restored by the inverse quantization and the inverse orthogonal transformation in this manner is output to the addition unit 20F.

The addition unit 20F adds the pixel value of the block in the coding unit output by the prediction mode determination unit 20L and the prediction residual of the pixel value of the block in the coding unit output by the inverse quantization/inverse transformation unit 20E. As a result, the decoded pixel value of the block in the coding unit is obtained. The decoded pixel value of the block in the coding unit obtained in this manner is output to the post filter unit 20G.

The post filter unit 20G applies a post filter to the decoded pixel value output by the addition unit 20F. In one aspect, the application of the post filter reduces a quantization error of the decoded pixel value. The decoded pixel value to which the post filter is applied in this manner is output to the frame memory 20H.

The decoded pixel value after the post filter is applied is drawn in the frame memory 20H. As a result, the picture of the video is accumulated in the frame memory 20H for each frame. For the pictures accumulated in this manner, a picture of a frame corresponding to an index of a reference picture is referred to at a time of inter-prediction. For example, the frame memory 20H may be implemented as a graphics memory or a video memory, or may be implemented as a partial storage area of the main memory.

The intra-prediction unit 203 determines an intra-prediction mode of the block in the prediction unit on the basis of the pixel value of the block in the prediction unit output by the block division unit 20A and a decoded pixel value of an adjacent pixel adjacent to the block in the prediction unit. Then, the intra-prediction unit 203 predicts, among the decoded pixel values of the adjacent pixels adjacent to the block in the prediction unit, the decoded pixel value corresponding to the previously determined intra-prediction mode as a pixel value of the block in the prediction unit. The pixel value of the block in the prediction unit predicted in this manner is output to the subtraction unit 20B via the prediction mode determination unit 20L, and the intra-prediction mode is output to the entropy coding unit 20D.

The inter-prediction unit 20K calculates a motion parameter, such as a reference picture, a motion vector, and the like, on the basis of the pixel value of the block in the prediction unit output by the block division unit 20A and a pixel value of a picture that may be referenced from the frame being processed among the pictures saved in the frame memory 20H. Then, the inter-prediction unit 20K refers to the pixel value of the reference picture corresponding to the index of the reference picture among the pictures saved in the frame memory 17 on the basis of the motion vector, thereby predicting a pixel value of the block in the prediction unit. The pixel value of the block in the prediction unit predicted in this manner is output to the subtraction unit 20B via the prediction mode determination unit 20L, and the motion parameter such as the motion vector, the index of the reference picture, and the like is output to the entropy coding unit 20D.

The prediction mode determination unit 20L determines a prediction mode of the block in the prediction unit on the basis of the prediction residual of the intra-prediction of the block in the prediction unit and the prediction residual of the inter-prediction of the block in the prediction unit. For example, in a case where the prediction mode of the block in the prediction unit is determined to be the intra-prediction, the prediction mode determination unit 20L outputs the pixel value of the block in the prediction unit predicted by the intra-prediction unit 203 to the addition unit 20F, and outputs the intra-prediction mode of the block in the prediction unit to the division shape determination unit 20M. On the other hand, in a case where the prediction mode of the block in the prediction unit is determined to be the inter-prediction, the prediction mode determination unit 20L outputs the pixel value of the block in the prediction unit predicted by the inter-prediction unit 20K to the addition unit 20F.

The division shape determination unit 20M determines a division shape of the block in the prediction unit.

In a case where the block in the coding unit is divided into blocks in rectangular prediction units as the division from the CU to the PU, the division shape is the same as H.264 or HEVC. Accordingly, hereinafter, an example in which a coding device performs GEO division for dividing the block in the coding unit into blocks in two non-rectangular prediction units will be described.

Here, a combination of the prediction modes of the blocks in the two prediction units having been subject to the GEO division may be any of four patterns of (1) Intra & Intra, (2) Intra & Inter, (3) Inter & Intra, and (4) Inter & Inter. For example, in a case where only one block in the prediction unit in which the prediction mode is the intra-prediction is included, that is, in the patterns of (2) and (3), the angle of the intra-prediction mode of the block in the prediction unit in which the prediction mode is the intra-prediction is used as the angle of the GEO partition. Furthermore, in a case where the prediction modes of both of the blocks in the two prediction units are the intra-prediction, that is, in the pattern of (1), the angle of the intra-prediction mode of the block in the prediction unit that shares a predetermined vertex of the block in the coding unit, for example, an upper-left vertex P [0, 0], is used as the angle of the GEO partition.

In such a situation where the angle of the GEO partition is determined, if the coordinates of one of division nodes P₀ and P₁ on the boundary of the block in the coding unit can be set, the coordinates of the other can be uniquely identified.

As merely an example, the division shape determination unit 20M may use GEO division information of the adjacent block adjacent to the block in the coding unit being processed. For example, in a case where the GEO division is performed in the adjacent block, it is possible to set, as the division node, one of two intersection points at which the extended line obtained by extending the line segment corresponding to the partition set in the adjacent block in the direction of the coding block being processed intersects the boundary of the coding block being processed. If it is possible to set, of the two intersection points, the intersection point closest to the adjacent block as the division node P₀, it is also possible to set the intersection point with a longer distance from the adjacent block as the division node P₁.

As another example, the division shape determination unit 20M may use the GEO division information of the reference picture referred to in frames before and after the coding block being processed. For example, it is possible to set the division nodes P₀ or P₁ at the positions same as those of the division nodes P₀ and P₁ set in the block referred to in the reference picture on the basis of the motion vector.

It becomes possible to identify the GEO partition when any two elements of the three elements of the angle of the GEO partition the positional information of the two division nodes. Accordingly, the division shape determination unit 20M outputs, to the block division unit 20A, any two elements of the three elements of the angle of the GEO partition and the positional information of the two division nodes. As a result, the block division unit 20A is enabled to divide the block in the coding unit into blocks in non-rectangular prediction units according to the GEO partition determined by the two elements.

Furthermore, the division shape determination unit 20M outputs the division node P₀ to the entropy coding unit 20D as GEO division information from the aspect of identifying the GEO partition on the side of the decoding device of the transmission destination.

[Process Flow]

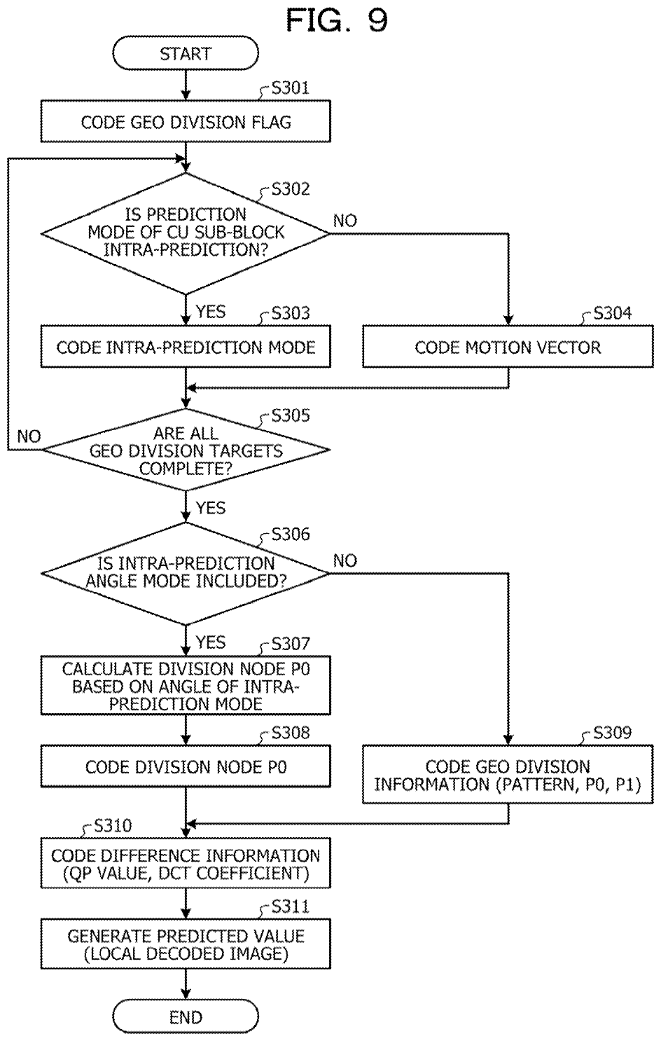

FIG. 9 is a flowchart illustrating a procedure of a coding process according to the second embodiment. This process is executed as merely an example when each picture of the video is input. As illustrated in FIG. 9, the entropy coding unit 20D codes the GEO division flag set in the block in the coding unit (step S301).

Subsequently, at a time of coding an intra/inter determination flag of the block in the prediction unit, which is a sub-block of the block in the coding unit, the entropy coding unit 20D determines whether the prediction mode of the sub-block is intra-prediction or inter-prediction on the basis of the intra/inter determination flag (step S302).

At this time, when the prediction mode of the sub-block is the intra-prediction, which is when the intra/inter determination flag is “1” (Yes in step S302), the entropy coding unit 20D codes the intra-prediction mode (step S303).

On the other hand, when the prediction mode of the sub-block is the inter-prediction, which is when the intra/inter determination flag is “0” (No in step S302), the entropy coding unit 20D codes the motion parameter such as the motion vector, the index of the reference picture, and the like (step S304).

Then, until the prediction modes of all the sub-blocks are determined (No in step S305), the process from step S302 described above to step S304 described above is repeated. Thereafter, when the prediction modes of all the sub-blocks are determined (Yes in step S305), the entropy coding unit 20D determines whether or not a sub-block in which the prediction mode is the intra-prediction is included in any of the sub-blocks of the block in the coding unit (step S306).

Here, if the sub-block in which the prediction mode is the intra-prediction is included in any of the sub-blocks of the block in the coding unit (Yes in step S306), the division shape determination unit 20M calculates the division node P₀ on the basis of the angle of the intra-prediction mode used for the intra-prediction by the intra-prediction unit 203 (step S307). Then, the entropy coding unit 20D codes the positional information of the division node P₀ as the GEO division information (step S308).

On the other hand, if no block in the prediction unit in which the prediction mode is the intra-prediction is included in any of the sub-blocks of the block in the coding unit (No in step S306), the entropy coding unit 20D codes the template number and the coordinates of the two division nodes P₀ and P₁ as the GEO division information (step S309).

The following process is carried out for each PU. For example, in a PU in which the prediction mode is the intra-prediction, the intra-prediction unit 203 predicts a pixel value of the PU on the basis of the intra-prediction mode coded in step S303 and the decoded pixel value of the adjacent pixel output from the addition unit 20F. Furthermore, in a PU in which the prediction mode is the inter-prediction, the inter-prediction unit 20K predicts a pixel value of the PU on the basis of the motion parameter coded in step S304, such as the motion vector and the index of the reference picture, and the pixel value of the reference picture output from the frame memory 20H. Then, the predicted value of the block in the coding unit corresponding to the prediction mode of the PU is subtracted from the pixel value of the block in the coding unit output by the block division unit 20A, thereby obtaining a prediction residual of the pixel value of the block in the coding unit. The prediction residual of the pixel value of the block in the coding unit obtained in this manner is output to the transformation/quantization unit 20C.

Thereafter, the entropy coding unit 20D codes the prediction residual (QP value and DCT coefficient) of the pixel value of the block in the coding unit having been subject to the quantization and the orthogonal transformation performed by the transformation/quantization unit 20C (step S310).

Furthermore, the addition unit 20F adds the pixel value of the block in the coding unit output according to the prediction mode of the block in the prediction unit and the prediction residual of the pixel value of the block in the coding unit, thereby generating a decoded pixel value of the block in the coding unit (step S311).

As described above, the coding device 2 according to the present embodiment codes the division node P₀ of the GEO partition calculated on the basis of the angle of the intra-prediction mode as the GEO division information.

Therefore, according to the coding device 2 according to the present embodiment, it becomes possible to suppress the code amount used to identify the non-rectangular division shape.

### Application Example

Next, an application example of the coding device 2 according to the present embodiment will be described. While the example of substituting the angle of the intra-prediction mode for the angle of the GEO partition to be identified has been described in the second embodiment above, it is also possible to substitute the angle of the GEO partition for the angle of the intra-prediction mode to be identified, and an example thereof will be exemplified below as an application example.

In the present application example, the coding device 2 performs the existing GEO division proposed by JVET-J0023. Meanwhile, the coding device 2 calculates the angle of the GEO partition on the basis of the template number and the coordinates of the two division nodes included in the GEO division information coded at the time of GEO division. Then, the coding device 2 selects, among the intra-prediction modes supported by WC, the intra-prediction mode of the angle corresponding to the angle of the GEO partition, that is, the angle closest to the angle of the GEO partition. By using the intra-prediction mode selected in this manner, the intra-prediction unit 203 carries out the intra-prediction in the sub-block in which the prediction mode is the intra-prediction among the sub-blocks of the block in the coding unit.

While an example of setting the intra-prediction mode corresponding to a fixed length of 5 bits is described here as merely an example, it is also possible to set the intra-prediction mode of the angle closest to the angle of the GEO partition as an MPM element. In this case, with an index for identifying the MPM element assigned to the sub-block in which the prediction mode is the intra-prediction, it becomes possible to suppress the code amount of the intra-prediction mode as compared with the fixed length.

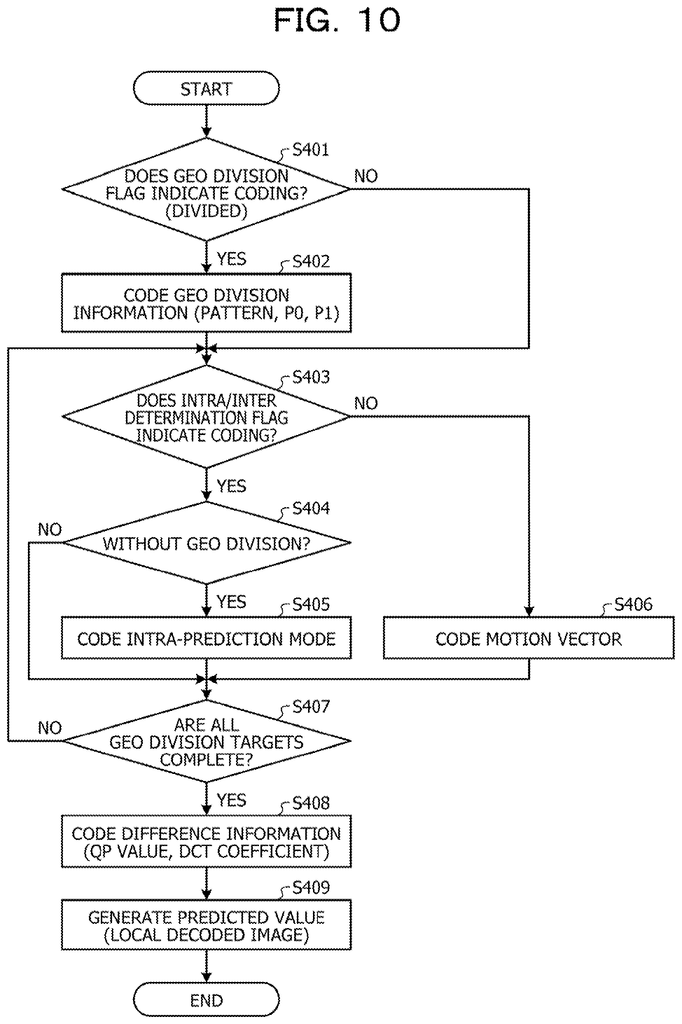

FIG. 10 is a flowchart illustrating a procedure of a coding process according to the application example of the second embodiment. This process is executed as merely an example when each picture of the video is input.

As illustrated in FIG. 10, when the GEO division flag of the block in the coding unit coded by the entropy coding unit 20D is “1”, which is when the GEO division is carried out in the block in the coding unit (Yes in step S401), the entropy coding unit 20D codes the GEO division information including the template number and the coordinates of the two division nodes obtained at the time of the GEO division performed by the block division unit 20A (step S402). Note that, when the GEO division flag is “0”, which is when no GEO division is carried out in the block in the coding unit (No in step S401), the processing of step S402 is skipped.

Subsequently, the entropy coding unit 20D determines whether the prediction mode of the sub-block is the intra-prediction or the inter-prediction on the basis of the intra/inter determination flag of the block in the prediction unit, which is the sub-block of the block in the coding unit (step S403).

At this time, when the prediction mode of the sub-block is the intra-prediction, which is when the intra/inter determination flag is “1” (Yes in step S403), an intra-prediction mode setting unit determines whether or not the block in the coding unit, which is the division source of the sub-block, is without the GEO division (step S404).

Here, if the block in the coding unit is without the GEO division (Yes in step S404), the entropy coding unit 20D codes the intra-prediction mode (step S405). On the other hand, if the block in the coding unit is not without the GEO division (No in step S404), the entropy coding unit 20D is allowed to omit the coding of the intra-prediction mode.

Furthermore, when the prediction mode of the sub-block is the inter-prediction, which is when the intra/inter determination flag is “0” (No in step S403), the entropy coding unit 20D codes the motion parameter such as the motion vector, the index of the reference picture, and the like (step S406).

Then, until the prediction modes of all the sub-blocks are determined (No in step S407), the process from step S403 described above to step S406 described above is repeated. Thereafter, when the prediction modes of all the sub-blocks are determined (Yes in step S407), the following process is carried out for each PU. For example, in a PU in which the prediction mode is the intra-prediction, the intra-prediction unit 203 predicts a pixel value of the PU on the basis of the intra-prediction mode coded in step S405 or the intra-prediction mode corresponding to the angle of the GEO partition and the decoded pixel value of the adjacent pixel output from the addition unit 20F. Furthermore, in a PU in which the prediction mode is the inter-prediction, the inter-prediction unit 20K predicts a pixel value of the PU on the basis of the motion parameter coded in step S304, such as the motion vector and the index of the reference picture, and the pixel value of the reference picture output from the frame memory 20H. Then, the predicted value of the block in the coding unit corresponding to the prediction mode of the PU is subtracted from the pixel value of the block in the coding unit output by the block division unit 20A, thereby obtaining a prediction residual of the pixel value of the block in the coding unit. The prediction residual of the pixel value of the block in the coding unit obtained in this manner is output to the transformation/quantization unit 20C.

Thereafter, the entropy coding unit 20D codes the prediction residual (QP value and DCT coefficient) of the pixel value of the block in the coding unit having been subject to the quantization and the orthogonal transformation performed by the transformation/quantization unit 20C (step S408).

Furthermore, the addition unit 20F adds the pixel value of the block in the coding unit output according to the prediction mode of the block in the prediction unit and the prediction residual of the pixel value of the block in the coding unit, thereby generating a decoded pixel value of the block in the coding unit (step S409).

As described above, the coding device 2 according to the application example of the second embodiment described above sets the intra-prediction mode corresponding to the angle of the GEO partition to the sub-block in which the prediction mode is the intra-prediction, and omits the coding of the intra-prediction mode at the time of GEO division. As a result, it becomes possible to suppress the code amount of the intra-prediction mode.

### Third Embodiment

While the embodiments related to the disclosed device have been described above, the present invention may be implemented in a variety of different modes in addition to the embodiments described above. Thus, hereinafter, another embodiment included in the present invention will be described.

Furthermore, individual components of each of the illustrated devices are not necessarily physically configured as illustrated in the drawings. For example, specific aspects of distribution and integration of the individual devices are not limited to those illustrated, and all or some of them may be functionally or physically distributed and integrated in any unit depending on various loads, use situations, and the like. For example, a part of the functional units included in the decoding device 1 may be connected via a network as an external device of the decoding device 1. Furthermore, a part of the functional units included in the decoding device 1 may be included in other devices, which are connected to a network to cooperate with each other, whereby the functions of the decoding device 1 described above may be implemented. For example, a part of the functional units included in the coding device 2 may be connected via a network as an external device of the coding device 2. Furthermore, a part of the functional units included in the coding device 2 may be included in other devices, which are connected to a network to cooperate with each other, whereby the functions of the coding device 2 described above may be implemented.

[Decoding Program]

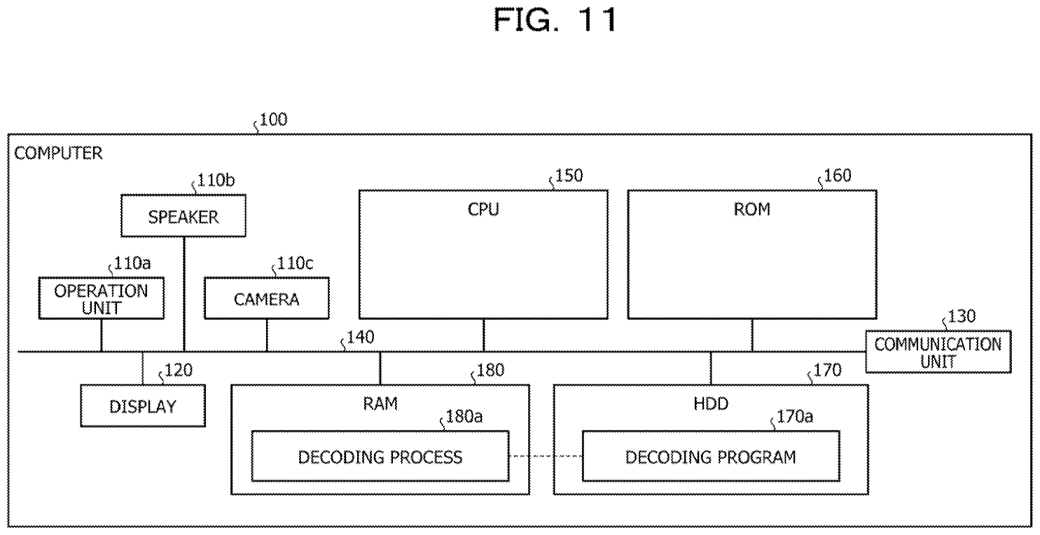

Furthermore, various types of processing described in the embodiments above may be implemented by a computer such as a personal computer or a workstation executing a program prepared in advance. In view of the above, hereinafter, an exemplary computer that executes a decoding program having functions similar to those in the first embodiment described above and the application example of the first embodiment described above will be described with reference to FIG. 11.

FIG. 11 is a diagram illustrating an exemplary hardware configuration of a computer. As illustrated in FIG. 11, a computer 100 includes an operation unit 110a, a speaker 110b, a camera 110c, a display 120, and a communication unit 130. Moreover, the computer 100 includes a CPU 150, a read-only memory (ROM) 160, an HDD 170, and a RAM 180. Those components 110 to 180 are each connected via a bus 140.

As illustrated in FIG. 11, the HDD 170 stores a decoding program 170a having functions similar to those of the individual functional units of the decoding device 1 described in the first embodiment described above. The decoding program 170a may be integrated or separated in a similar manner to the individual components of the decoding device 1 illustrated in FIG. 1. For example, all the data indicated in the first embodiment described above are not necessarily stored in the HDD 170, and it is sufficient if only data for use in processing is stored in the HDD 170.

Under such an environment, the CPU 150 reads out the decoding program 170a from the HDD 170, and loads it in the RAM 180. As a result, the decoding program 170a functions as a decoding process 180a as illustrated in FIG. 11. The decoding process 180a loads various kinds of data read out from the HDD 170 in an area allocated to the decoding process 180a in a storage area of the RAM 180, and executes various kinds of processing using the various kinds of loaded data. For example, examples of the processing to be executed by the decoding process 180a include the processing illustrated in FIGS. 6 and 7. Note that all the processing units indicated in the first embodiment described above do not necessarily operate in the CPU 150, and it is sufficient if only a processing unit corresponding to processing to be executed is virtually implemented.

Note that the decoding program 170a described above does not necessarily stored in the HDD 170 or the ROM 160 from the beginning. For example, the decoding program 170a is stored in a “portable physical medium” such as a flexible disk, which is what is called an FD, a compact disc (CD)-ROM, a digital versatile disk (DVD), a magneto-optical disk, or an integrated circuit (IC) card to be inserted in the computer 100. Then, the computer 100 may obtain and execute the decoding program 170a from those portable physical media. Furthermore, the decoding program 170a may be stored in another computer, a server device, or the like connected to the computer 100 via a public line, the Internet, a local area network (LAN), a wide area network (WAN), or the like, and the computer 100 may obtain and execute the decoding program 170a from them.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A decoding device comprising:
one or more memories; and
one or more processors coupled to the one or more memories and the one or more processors configured to:
acquire a division shape of a block in a non-rectangular prediction unit based on positional information of one division node of two division nodes at which a partition that divides a block in a coding unit included in coded data into the block in the non-rectangular prediction unit intersects a boundary of the block in the coding unit and an angle of an intra-prediction mode used to perform intra-prediction in the block in the non-rectangular prediction unit, and
perform intra-prediction of the block in the non-rectangular prediction unit obtained by dividing the block in the coding unit based on the division shape using the intra-prediction mode.

2. The decoding device according to claim 1, wherein
the positional information of the division node includes a distance obtained by searching the boundary of the block from an upper left vertex of the block in the coding unit to the division node.

3. The decoding device according to claim 2, wherein
when the intra-prediction refers to a left adjacent pixel of the block in the coding unit, the positional information of the division node includes a distance obtained by searching the boundary of the block counterclockwise from the upper left vertex of the block in the coding unit to the division node.

4. The decoding device according to claim 2, wherein
when the intra-prediction refers to an upper adjacent pixel of the block in the coding unit, the positional information of the division node includes a distance obtained by searching the boundary of the block clockwise from the upper left vertex of the block in the coding unit to the division node.

5. The decoding device according to claim 1, wherein the one or more processors are further configured to
encode the positional information of the division node.

6. The decoding device according to claim 1, wherein the one or more processors are further configured to:
acquire an angle of a partition based on the two division nodes, and
set the intra-prediction mode that corresponds to the angle of the partition in the block in the non-rectangular prediction unit in which a prediction mode is intra-prediction, or set the intra-prediction mode that corresponds to the angle of the partition as a most probable mode (MPM) element of the intra-prediction.

7. The decoding device according to claim 6, wherein the one or more processors are further configured to:
encode, when the non-rectangular division is not performed on a block in a prediction unit in which the prediction mode is the intra-prediction, the intra-prediction mode used for the intra-prediction of the block in the prediction unit, and
skip encoding of the intra-prediction mode that corresponds to the angle of the partition when the non-rectangular division is performed on the block in the prediction unit in which the prediction mode is the intra-prediction.

8. A decoding method for a computer to execute a process comprising:
acquiring a division shape of a block in a non-rectangular prediction unit based on positional information of one division node of two division nodes at which a partition that divides a block in a coding unit included in coded data into the block in the non-rectangular prediction unit intersects a boundary of the block in the coding unit and an angle of an intra-prediction mode used to perform intra-prediction in the block in the non-rectangular prediction unit; and
performing intra-prediction of the block in the non-rectangular prediction unit obtained by dividing the block in the coding unit based on the division shape using the intra-prediction mode.

9. A non-transitory computer-readable storage medium storing a decoding program that causes at least one computer to execute a process, the process comprising:
acquiring a division shape of a block in a non-rectangular prediction unit based on positional information of one division node of two division nodes at which a partition that divides a block in a coding unit included in coded data into the block in the non-rectangular prediction unit intersects a boundary of the block in the coding unit and an angle of an intra-prediction mode used to perform intra-prediction in the block in the non-rectangular prediction unit; and
performing intra-prediction of the block in the non-rectangular prediction unit obtained by dividing the block in the coding unit based on the division shape using the intra-prediction mode.
